(19) United States
(12) Patent Application Publication
(10) Pub. No.: US 2025/0018700 A1
(43) Pub. Date: Jan. 16, 2025

(54) SUPPORT UNIT

(71) Applicants: Hefei Visionox Technology Co., Ltd., Hefei (CN); KunShan Go-Visionox Opto-Electronics Co., Ltd, Kunshan, Jiangsu (CN)

(72) Inventors: Gusheng XU, Hefei (CN); Xiaodong AI, Hefei (CN); Shuhuan ZHANG, Hefei (CN)

(73) Assignees: Hefei Visionox Technology Co., Ltd., Hefei (CN); KunShan Go-Visionox Opto-Electronics Co., Ltd, Kunshan (CN)

(21) Appl. No.: 18/901,433

(22) Filed: Sep. 30, 2024

(30) Foreign Application Priority Data
Oct. 9, 2023 (CN) 202311309305.6

(51) Int. Cl. B32B 27/20; B32B 27/08; B32B 27/26; B32B 27/28; B32B 27/36; B32B 27/38; G06F 1/16

(52) U.S. Cl. CPC B32B 27/20; B32B 27/08; B32B 27/26; B32B 27/281; B32B 27/36; B32B 27/38; G06F 1/1652; G06F 1/1656; B32B 2250/02; B32B 2250/24; B32B 2307/51; B32B 2307/7265; B32B 2307/7376; B32B 2363/00; B32B 2367/00; B32B 2379/08; B32B 2457/20

(57) ABSTRACT

A support unit is arranged on a non-light-emitting surface of the display panel. The support unit includes a support plate and an isolation layer. The support plate is located on a side of the display panel. The isolation layer is located on a side of the support plate away from the display panel, and includes at least one of a moisture-isolating layer or a heat-isolating layer.

### CROSS REFERENCES TO RELATED APPLICATIONS

This application claims a priority of Chinese Patent Application No. 202311309305.6, filed on Oct. 9, 2023 and titled by “SUPPORT UNIT, DISPLAY MODULE AND DISPLAY DEVICE”, which is incorporated herein in its entirety.

### TECHNICAL FIELD

The present application relates to the technical field of display, and in particular to a support unit, a display module and a display device.

### BACKGROUND

With the development of display technology, the light-and-thin requirement of a display device is becoming increasingly high. A display module inside the display device includes a support plate, which can be reduced in weight to meet the light-and-thin requirement of the display device. It is necessary to meet the support strength requirement while reducing the weight of the support plate. Therefore, the support plate made of a carbon fiber material is often used in a related art, so as to reduce the weight of the support plate while meeting the support strength requirement. However, during the reliability testing of the display module, there are some defects in the support plate made of the carbon fiber material, which may seriously affect the yield of the display device.

### SUMMARY

Embodiments of the present application provide a support unit, a display module and a display device, which can solve the bulging problem in the display module in the reliability testing and improve the product yield.

In a first aspect, embodiments of the present application provide a support unit, which is arranged on a non-light-emitting surface of a display panel. The support unit includes: a support plate, located on a side of the display panel; and
an isolation layer, located on a side of the support plate away from the display panel, and including at least one of a moisture-isolating layer or a heat-isolating layer.

In a second aspect, embodiments of the present application provide another support unit, which is arranged on a non-light-emitting surface of a display panel. The support unit includes:
a support plate, which is located on a side of the display panel, and components of the support plate include a moisture-absorbing material.

In a third aspect, embodiments of the present application provide another support unit, which is arranged on a non-light-emitting surface of a display panel. The support unit includes:
a support plate, which is located on a side of the display panel, and components of the support plate include epoxy resin, carbon filament, curing agent, antioxidant and curing accelerator, and the curing agent including aliphatic amine curing agent or aromatic diamine curing agent.

In a fourth aspect, embodiments of the present application provide a display module, including the support unit according to any one of embodiments as described above.

In a fifth aspect, embodiments of the present application provide a display device including the display module according to any one of the embodiments in the fourth aspect.

### BRIEF DESCRIPTION OF THE DRAWINGS

In order to more clearly illustrate the technical solutions of the embodiments of the present application, the drawings to be used in the description of the embodiments of the present application will be described briefly below. Obviously, the drawings in the following description are merely some embodiments of the present application. For those skilled in the art, other drawings can also be obtained according to these drawings without the inventive labor.

FIG. 1 is a structural schematic view of a support unit according to an embodiment of the present application;

FIG. 2 is a cross-sectional view along line P-P′ in FIG. 1;

FIG. 3 is a view in a using state in FIG. 2;

FIG. 4 is another cross-sectional view along line P-P′ in FIG. 1;

FIG. 5 is another cross-sectional view along line P-P′ in FIG. 1;

FIG. 6 is another cross-sectional view along line P-P′ in FIG. 1;

FIG. 7 is another cross-sectional view along line P-P′ in FIG. 1;

FIG. 8 is another cross-sectional view along line P-P′ in FIG. 1;

FIG. 9 is a structural schematic view of another support unit according to an embodiment of the present application;

FIG. 10 is a structural schematic view of a support plate of another support unit according to an embodiment of the present application;

FIG. 11 a structural schematic view of an isolation layer of another support unit according to an embodiment of the present application;

FIG. 12 is a structural schematic view of another support unit according to an embodiment of the present application;

FIG. 13 is a structural schematic view of another support unit according to an embodiment of the present application;

FIG. 14 is a structural schematic view of a display module according to an embodiment of the present application;

FIG. 15 is a cross-sectional view along line Q-Q′ in FIG. 14; and

FIG. 16 is a structural schematic view of a display device according to an embodiment of the present application.

In the drawings:
1—display module; 10—support unit; 11—display panel; 110—light-emitting side; 111—non-light-emitting surface; 12—support plate; 121—first stress-releasing hole; 13—isolation layer; 131—moisture-isolating layer; 1311 water-oxygen-isolating film; 14—adhesive layer; 1312—inorganic film-coating layer; 1313—inorganic material layer; 1314 organic material layer; 132—heat-isolating layer; 1321—carrier layer; 1322—metal film-coating layer; 133—second stress-releasing hole; 15—support film; 16—double-face adhesive tape; 17—polarizer; 18—cover plate; 19—transparent optical adhesive; A1 bending region; A2—non-bending region; 2—display device.

### DETAILED DESCRIPTION

Features and exemplary embodiments in various aspects of the present application will be described in detailed below. To make the objects, technical solutions and advantages of the present disclosure to be more apparent, the present disclosure will be further described in detail below with reference to the accompanying drawings and specific embodiments. It shall be understood that the specific embodiments described herein are only to be construed as illustrative and not limiting. To those skilled in the art, the present application can be implemented without some of the specific details. The description of embodiments below is intended merely to provide a better understanding of the present application by showing examples of the present application.

It shall be noted that, in this context, relational terms such as first and second are merely used to distinguish one entity or operation from another entity or operation, and do not necessarily require or imply any such actual relationship or order between the entities or operations. Further, the term “comprise”, “include” or any other variations thereof is intended to encompass a non-exclusive inclusion, such that a process, method, article, or device including a plurality of elements includes not only these elements but also other elements not listed, or elements that are inherent to such process, method, article or device. Without more limitations, an element that is defined by an expression “comprises . . . ”, does not exclude other identical elements in the process, method, article, or device including this element.

After researching, the inventors found that, with the development of display technology, the light-and-thin requirement of a display device is becoming increasingly high. Especially in foldable mobile phone products, the light-and-thin requirement is more significant. The types of foldable mobile phone products are increasing, and the competition among various terminals is becoming increasingly fierce. In order to maintain the competitiveness and improve the user experience, the foldable mobile phone products are now developing towards slimness. In the traditional foldable mobile phone products, a support plate in a support unit is usually made of the metal material, which accounts for a high proportion of weight. Therefore, at present, the products may be made of the carbon fiber instead of the traditional metal material. Compared with the metal material, the carbon fiber has the similar strength but the lighter weight, which has a significant weight reduction effect on the support unit. However, the support plate is usually composed of multiple layers of sheet materials, and the sheet materials themselves are made of the carbon fiber formed by the carbon filament coated with the epoxy resin. The material may react with the moisture under the high temperature condition, release the gas, and cause the support unit to bulge in the reliability testing process, which may seriously affect the product yield. Based on the research on the above problems, the inventors provide a support unit, a display module and a display device, so as to solve the bulging problem in the support unit in the reliability testing and improve the yield of the support unit.

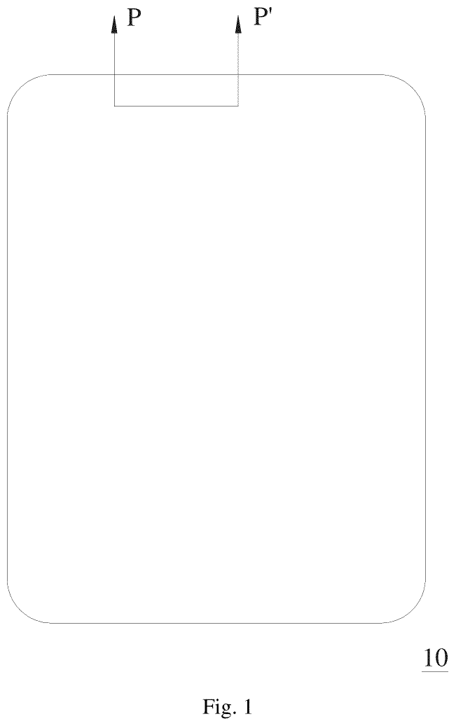

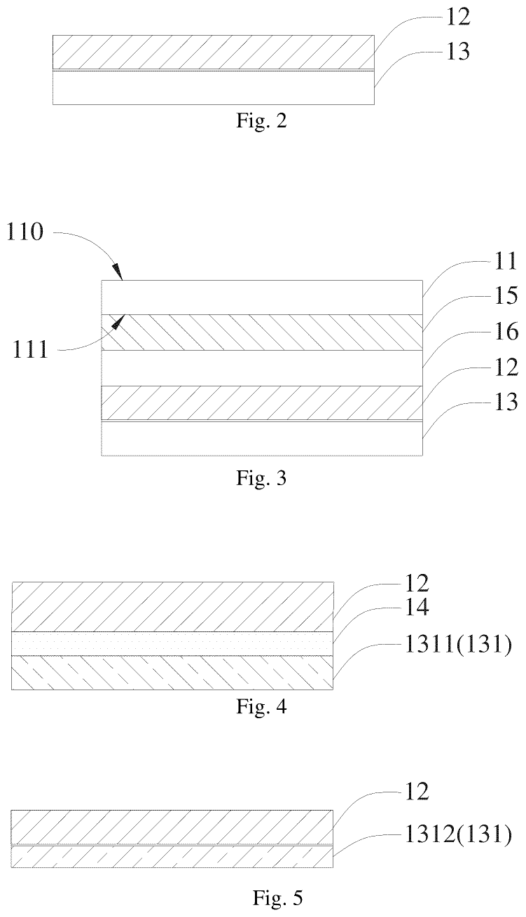

In order to better understand the present application, a support unit, a display module, and a display device according to embodiments of the present application will be described in detail below with reference to FIG. 1 to FIG. 16.

Referring to FIG. 1 to FIG. 8, embodiments of the present application provide a support unit 10, which is arranged on a non-light-emitting surface 111 of a display panel 11. The support unit includes a support plate 12 and an isolation layer 13. The display panel 11 includes a light-emitting side 110 for displaying images. The support plate 12 is located on a side of the display panel 11 away from the light-emitting side 110, that is, the non-light-emitting surface 111. The isolation layer 13 is located on a side of the support plate 12 away from the display panel 11, and includes at least one of a moisture-isolating layer 131 or a heat-isolating layer 132.

The support unit 10 provided by the present application includes the support plate 12 and the isolation layer 13. The support unit 10 is arranged on the non-light-emitting surface 111 of the display panel 11, which can be a flexible display panel 11. The support plate 12 is used to support the display panel 11. The isolation layer 13 is used to isolate the moisture from the light-emitting side 110 of the display panel 11 or to isolate the heat, so as to reduce the interference on the support unit by the environmental factors outside the support unit 10.

Specifically, the support plate 12 can be made of a carbon fiber material, which has the strong hardness and light weight, so as to reduce the weight of the support unit 10 and meet the support performance requirement, thereby achieving the light-and-thin support unit 10. Specifically, the support plate 12 can be composed of a carbon fiber sheet material. The carbon fiber sheet material is formed by means of curing and cutting a pre-impregnated material, followed by bonding, hot pressing and cutting. The pre-impregnated material includes epoxy resin, carbon filament, curing agent, antioxidant, curing accelerator or the like. The epoxy resin is used to bond, and the commonly used curing agent includes dicyandiamide. The dicyandiamide reacts with the moisture at a high temperature to generate the gas, which diffuses towards a side close to the display panel 11 and can easily cause defects in the support unit 10, such as the bulging phenomenon. Specifically, when the temperature is high, specifically higher than 80° C., the dicyandiamide is prone to react with the moisture: C₂H₄N₄+2H₂O=2NH₃ ↑+CO₂ ↑+H₂NCN, thereby generating the gas.

As shown in FIG. 4 to FIG. 6, in the support unit 10 provided by the present application, by arranging at least one of a moisture-isolating layer 131 or a heat-isolating layer 132 on the side of the support plate 12 away from the display panel 11, the reaction condition between the dicyandiamide and the moisture can be disrupted, so as to suppress the reaction, solve the bulging problem and improve the yield of the support unit 10.

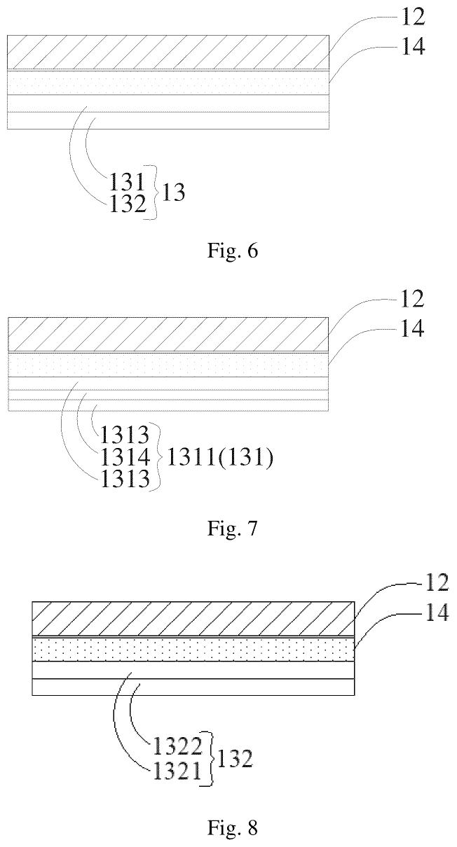

Specifically, the moisture-isolating layer 131 can prevent the moisture from contacting with the support plate 12, thereby preventing the dicyandiamide from contacting and reacting with the moisture to eliminate or reduce the gas production. The heat-isolating layer 132 can isolate the temperature of the environment, so as to prevent the high temperature from entering into an interior of the support unit 10, that is, to lower the temperature of the support plate 12, thereby disrupting the temperature condition for the reaction between the dicyandiamide and the moisture. Therefore, the dicyandiamide cannot react with the moisture to eliminate or reduce the gas production. In the support unit 10 provided by the present application, the isolation layer 13 includes at least one of the moisture-isolating layer 131 or the heat-isolating layer 132, which can disrupt the conditions for the chemical reaction of the dicyandiamide and for generating the gas, thereby reducing or eliminating the gas production. As shown in FIG. 6, when the isolation layer 13 includes both the moisture-isolating layer 131 and the heat-isolating layer 132, the moisture-isolating layer 131 may be located on a side of the heat-isolating layer 132 close to or away from (not shown in the Figure) the display panel 11, and the present application does not specifically limit this.

In a feasible embodiment, a moisture permeability of the moisture-isolating layer 131 is less than or equal to 10⁻⁴ g/(m²·d).

In the above embodiment, the moisture permeability of the moisture-isolating layer 131 is less than or equal to 10⁻⁴ grams per square meter per day, which can effectively suppress the amount of gas generated by the reaction between the moisture and the dicyandiamide after the moisture being in contact with the support plate 12, thereby improving the yield of the support unit 10. Specifically, the moisture permeability of the moisture-isolating layer 131 may be 0.00001 g/(m²·d), 0.00003 g/(m²·d), 0.00005 g/(m²·d), 0.00008 g/(m²·d), 0.00009 g/(m²·d), 0.0001 g/(m²·d) and so on, and the present application is not particularly limited to this.

In a feasible embodiment, an elastic modulus of the moisture-isolating layer 131 is larger than or equal to 3 GPa and less than or equal to 8 GPa, and specifically, may be 3 GPa, 4 GPa, 5 GPa, 7 GPa, 8 GPa or the like. The present application is not particularly limited to this. The elastic modulus of the moisture-isolating layer 131 is set within the above range, so that the flexibility of the moisture-isolating layer 131 can be ensured, and the moisture-isolating layer can be arranged on the non-light-emitting surface 111 of the flexible display panel.

In a feasible embodiment, as shown in FIG. 4, the moisture-isolating layer 131 includes a water-oxygen-isolating film 1311, which is bonded and fixed to the support plate 12 through an adhesive layer 14.

In the above embodiment, the moisture-isolating layer 131 can include a water-oxygen-isolating film 1311, which is an independent film layer that can be attached to a side of the support plate 12 away from the display panel 11. Specifically, the water-oxygen-isolating film 1311 can be bonded and fixed to the support plate 12 through the adhesive layer 14. The arrangement of the moisture-isolating layer 131 is simple, the operate of the moisture-isolating layer is convenient, and the requirement of the manufacturing process is relatively low.

In the above embodiment, the water-oxygen-isolating film 1311 includes at least one of an inorganic material film layer or a metal material film layer.

When the water-oxygen-isolating film 1311 is the inorganic material film layer, the inorganic material film layer may be specifically silicon nitride, silicon oxide, silicon oxynitride or the like. The inorganic material is commonly used to manufacture the display panel 11, has the low cost, and has the good performance of isolating the water oxygen.

When the water-oxygen-isolating film 1311 is the metal film layer, the metal film layer may be specifically copper foil or the like. When the water-oxygen-isolating film 1311 is the metal film layer, due to the good heat-insulating effect of the metal material film layer, the water-oxygen-isolating film 1311 can not only isolate the moisture but also isolate the heat, thus has a better inhibitory effect on the gas generated by the chemical reaction of the dicyandiamide.

In the above embodiments, the water-oxygen-isolating film 1311 further includes an organic material. The organic material has good flexibility and extensibility, which can improve the bending performance of the water-oxygen-isolating film 1311.

Specifically, as shown in FIG. 7, the water-oxygen-isolating film 1311 includes an inorganic material layer 1313, an organic material layer 1314 and an inorganic material layer 1313 stacked in a direction perpendicular to the support plate 12. Among them, the inorganic material layer 1313 can be used to isolate the water oxygen, and two stacked inorganic material layers 1313 can further improve the effect of isolating water and oxygen. The organic material layer 1314 is arranged between two inorganic material layers 1313, so that the mutual influence of stress between the two inorganic material layers 1313 can be reduced, the flexibility of the water-oxygen-isolating film 1311 can be improved, the risk of fracture and failure of the inorganic material layer 1313 after being bent can be reduced, and the reliability of the water-oxygen-isolating film 1311 can be improved.

Specifically, a thickness of the water-oxygen-isolating film 1311 ranges from 10 μm to 30 μm.

The too small thickness of the water-oxygen-isolating film 1311 is not conducive to achieve the moisture-isolating effect, and the too large thickness of the water-oxygen-isolating film 1311 is not conducive to achieving the light-and-thin support unit 10. By setting the thickness of the water-oxygen-isolating film 1311 within the above thickness range, a balance between the moisture-isolating effect and the overall thickness of the support unit 10 can be achieved.

Specifically, the thickness of the water-oxygen-isolating film 1311 may be 10 μm, 11 μm, 13 μm, 16 μm, 20 μm, 21 μm, 24 μm, 28 μm, 30 μm or the like, and the present application does not specially limit this.

In a feasible embodiment, as shown in FIG. 5, the moisture-isolating layer 131 includes an inorganic film-coating layer 1312, which is fixed to the side of the support plate 12 away from the display panel 11 and in contact with the support plate 12.

In the above embodiment, the inorganic film-coating layer 1312 can be formed on the moisture-isolating layer 131 by sputtering the inorganic material onto a surface on the side of the support plate 12 away from the display panel 11 be means of a sputtering process. The inorganic material is attached to the side of the support plate 12 away from the display panel 11 to form the inorganic film-coating layer 1312. The inorganic film-coating layer 1312 is in contact with and fixed to the support plate 12, without the need for any other fixing process.

The inorganic film-coating layer formed by the above manufacturing process has a thinner thickness and can be fixed to the support plate 12 without the need for other fixing processes or film layers, which can further reduce the thickness of the support unit 10.

In the above embodiment, the thickness of the inorganic film-coating layer 1312 is 10 nm to 100 nm.

Specifically, the thickness of the inorganic film-coating layer 1312 may be 10 nm, 15 nm, 20 nm, 23 nm, 35 nm, 42 nm, 56 nm, 78 nm, 100 nm and so on, and the present application dose not particularly limit this. It can be understood that within the above thickness range, the larger the thickness of the inorganic film-coating layer 1312 is, the better the isolating-moisture effect is. The smaller the thickness of the inorganic film-coating layer 1312 is, the shorter the manufacturing time is, which is conducive to reducing the manufacturing cost and the material cost.

In a feasible embodiment, as shown in FIG. 8, the heat-isolating layer 132 includes a carrier layer 1321 and a metal film-coating layer 1322. The carrier layer 1321 is fixed to the side of the support plate 12 away from the display panel 11, and the metal film-coating layer 1322 is fixed to a side of the carrier layer 1321 away from the support plate 12.

In the above embodiment, the heat-isolating layer 132 includes the metal film-coating layer 1322, and the thermal reflection performance of the metal film-coating layer 1322 can reflect the heat, that is, the metal film-coating layer 1322 has a good insulation effect on the high temperature, which can disrupt the temperature required for the reaction between the moisture and the dicyandiamide, and avoid the bulging phenomenon. However, the metal is not easily attached to the support plate 12, so the metal film-coating layer 1322 is carried by the carrier layer 1321. The carrier layer 1321 can be formed on the side of the support plate 12 away from the display panel 11 through a coating process, or attached to the side of the support plate 12 away from the display panel 11 through the adhesive layer 14, and the present application does not particularly limit this. In a specific embodiment, the metal can be directly plated onto a surface of the carrier layer 1321 on a side away from the support plate 12 to form the metal film-coating layer 1322, and no other fixing process is required between the metal film-coating layer 1322 and the carrier layer 1321.

In the above embodiments, the carrier layer 1321 includes the organic material. The metal has the good bonding effect on the organic material, which can enhance the fixing strength of the metal film-coating layer 1322.

In the above embodiments, the organic material includes polyester or polyimide, which has the low cost and is beneficial to reducing the manufacturing cost.

In the above embodiments, the material of the metal film-coating layer 1322 includes at least one of gold, silver, nickel or aluminum. Some common metal materials has been listed above, and other metal materials can also be used in the present application, which is not particularly limited in the present application.

In the above embodiment, a thickness of the carrier layer 1321 is from 5 μm to 15 μm. When the thickness of the carrier layer 1321 is too small, it is not conducive to controlling the film formation accuracy, and when the thickness of the carrier layer 1321 is too large, it is not conducive to achieving the light-and-thin support unit 10. By setting the thickness of the carrier layer 1321 within the above range, it can take into account both the manufacturing difficulty of the bearing layer 1321 and the lightening requirement of the support unit 10.

Specifically, the thickness of the carrier layer 1321 may be 5 μm, 6 μm, 8 μm, 11 μm, 14 μm, 15 μm or the like, and the present application does not specially limit this.

In the above embodiment, the thickness of the metal film-coating layer 1322 is from 100 nm to 500 nm.

Specifically, the thickness of the metal film-coating layer 1322 may be 100 nm, 102 nm, 113 nm, 124 nm, 135 nm, 180 nm, 256 nm, 368 nm, 371 nm, 420 nm, 489 nm, 500 nm or the like, and the present application does not specially limit this.

When the thickness of the metal film-coating layer 1322 is too small, the heat-isolating effect is difficult to meet the requirement; when the thickness of the metal film-coating layer 1322 is too large, the material cost is high, and it is not conducive to achieving the light-and-thin support unit 10. By setting the thickness of the metal film-coating layer 1322 within the above range, both the heat-isolating effect and the light-and-thin display panel 11 can be achieved, and the manufacturing cost can be saved.

In a feasible embodiment, components of the support plate 12 include epoxy resin, carbon filament, curing agent, antioxidant and curing accelerator.

In the above embodiments, the support plate 12 is made of carbon fiber material, which has the strong hardness and the light weight, and is conducive to reducing the weight of the support unit 10 while meeting the support performance, thereby achieving the light-and-thin support unit 10. The epoxy resin is doped with the curing agent, the antioxidant, and the curing accelerator, and then applied with the carbon filament to form a carbon fiber sheet material. The support plate 12 can be composed of multiple layers of carbon fiber sheet materials. The epoxy resin is used to bond, and the curing agent is used to achieve the curing of the epoxy resin. The antioxidant can be used to prevent from or delay aging, so as to allow the carbon fiber material to maintain its original good performance and improve the stability and reliability of the support plate 12. The curing accelerator can accelerate the reaction rate between the epoxy resin and the curing agent, so as to lower the curing reaction temperature and shorten the curing time.

In the above embodiment, a mass proportion of the carbon filament in the support plate 12 is from 72% to 78%. When the mass proportion of the carbon filament is relatively low, it is not easy to meet the requirement of support performance; when the mass proportion of the carbon filament is relatively high, it is not easy to meet the bending-and-folding requirement of the flexible support unit 10. By setting the mass proportion of the carbon filament within the above range, both the support performance and the flexibility can be achieved.

Specifically, the mass proportion of the carbon filament may be 72%, 73.5%, 75%, 77.25%, 78% or the like, and the present application does not specially limit this.

A mass proportion of the epoxy resin is from 20.5% to 25.5%. When the mass proportion of the epoxy resin is relatively low, it is not easy to meet the requirement of adhesive strength; when the mass proportion of the epoxy resin is relatively high, the mass proportion of the carbon filament is too low to meet the requirement of support performance. By setting the mass proportion of the epoxy resin within the above range, both the support performance and the adhesive strength can be achieved.

Specifically, the mass proportion of the epoxy resin may be 20.5%, 21%, 23.45%, 25%, 25.5% or the like, and the present application does not specially limit this.

A mass proportion of the curing agent is from 1% to 1.4%; a mass proportion of the antioxidant is from 0.05% to 0.1%; a mass proportion of the curing accelerator is from 0.45% to 1%. Specifically, they can be selected according to the actual needs and fluctuate within the above ranges.

Specifically, in the support plate, the mass proportion of the carbon filament is 72%; the mass proportion of the epoxy resin is 25.5%; the mass proportion of the curing agent is 1.4%; the mass proportion of the antioxidants is 0.1%; the mass proportion of the curing accelerator is 1%. Alternatively, in the support plate, the mass proportion of the carbon filament is 73.75%; the mass proportion of the epoxy resin is 24.55%; the mass proportion of the curing agent is 1.13%; the mass proportion of the antioxidant is 0.07%; the mass proportion of the curing accelerator is 0.5%. Alternatively, in the support plate, the mass proportion of the carbon filament is 74.39%; the mass proportion of the epoxy resin is 23.36%; the mass proportion of the curing agent is 1.25%; the mass proportion of the antioxidant is 0.09%; the mass proportion of the curing accelerator is 0.91%. Alternatively, in the support plate, the mass proportion of the carbon filament is 78%; the mass proportion of the epoxy resin is 20.5%; the mass proportion of the curing agent is 1%; the mass proportion of the antioxidant is 0.05%; the mass proportion of the curing accelerator is 0.45%.

In the above embodiment, the antioxidant includes at least one of diaryl secondary amine or p-phenylenediamine derivative.

In the above embodiment, the curing accelerator includes at least one of dimethylamino-methylphenol or benzyl dimethylamine.

In the above embodiment, the curing agent includes aliphatic amine curing agent or aromatic diamine curing agent. The aliphatic amine curing agent includes at least one of ethylenediamine, hexamethylenediamine, diethylenetriamine or triethylenetetramine; the aromatic diamine curing agent includes at least one of dapsone, diaminodiphenylmethane or m-phenylenediamine. In this case, the curing agent may not include dicyandiamide, so as to eliminating the gas generated by the reaction between the dicyandiamide and the moisture.

In the above embodiments, the curing agent may be the dicyandiamide. Due to the isolation layer 13, it can isolate the moisture at the side of the display panel 11 away from the light-emitting side 110 or the heat, so as to disrupt the reaction conditions between the dicyandiamide and the moisture, suppress the reaction, and solve the bulging problem.

In other embodiments, the curing agent includes the dicyandiamide, and the support plate 12 further includes a moisture-absorbing material. By doping the moisture-absorbing material into the support plate 12, the moisture can be absorbed by the moisture-absorbing material firstly after entering into the support plate 12, so as to preventing the moisture from reacting with the curing agent including the dicyandiamide material, reduce the probability of generating the gas by the reaction between the dicyandiamide in the curing agent and the moisture, and improve the yield of the support unit 10. In the above embodiment, the moisture-absorbing material includes at least one of acrylic ester, polyvinyl alcohol, vinyl acetate copolymer, polyurethane, polyethylene oxide or starch graft copolymer. The present application does not particularly limit this and the components can be selected according to the actual needs.

In the above embodiment, in the support plate 12, the mass proportion of the carbon filament is from 70% to 75%. When the mass proportion of the carbon filament is relatively low, it is not easy to meet the requirement of support performance; when the mass proportion of the carbon filament is too high, it is not easy to meet the bending-and-folding requirement of the flexible support unit 10. By setting the mass proportion of the carbon filament within the above range, both the support performance and the flexibility can be achieved.

Specifically, the mass proportion of the carbon filament may be 70%, 71.2%, 72%, 73.68%, 75% or the like, and the present application does not specially limit this.

In the above embodiment, in the support plate 12, the mass proportion of the epoxy resin is from 20% to 25%. When the mass proportion of the epoxy resin is relatively low, it is not easy to meet the requirement of adhesive strength; when the mass proportion of the epoxy resin is too high, the mass proportion of the carbon filament is too low to meet the requirement of support performance. By setting the mass proportion of the epoxy resin within the above range, the support performance and the adhesive strength can be achieved.

In the above embodiment, in the support plate 12, the mass proportion of the curing agent is from 1% to 1.5%. The mass proportion of the antioxidant is from 0.05% to 0.1%. The mass proportion of the curing accelerator is from 0.5% to 1%. Specifically, they can be selected according to the actual needs and fluctuate within the above ranges.

In the above embodiment, in the support plate 12, the mass proportion of the moisture-absorbing material is from 2% to 2.5%. When the mass proportion of the moisture-absorbing material is too low, it is not easy to meet the requirement of water-absorption performance. In this case, there is still a lot of gas generated in the support plate 12, which may cause defects such as bulging. When the mass proportion of the moisture-absorbing material is too high, although it can meet the requirement of water-absorption performance, it may affect the mass proportion of other components, thereby affecting other properties.

Specifically, the mass proportion of the moisture-absorbing material may be 2%, 2.1%, 2.3%, 2.4%, 2.5% or the like, and the present application does not specially limit this.

Specifically, in the support plate, the mass proportion of the carbon filament is 75%; the mass proportion of the epoxy resin is 21%; the mass proportion of the curing agent is 1%; the mass proportion of the absorbent material is 2%; the mass proportion of the antioxidant is 0.1%; the mass proportion of the curing accelerator is 0.9%. Alternatively, in the support plate, the mass proportion of the carbon filament is 71.25%; the mass proportion of the epoxy resin is 24.3%; the mass proportion of the curing agent is 1.4%; the mass proportion of the moisture-absorbing material is 2.23%; the mass proportion of the antioxidant is 0.07%; the mass proportion of the curing accelerator is 0.75%. Alternatively, in the support plate, the mass proportion of the carbon filament is 73.7%; the mass proportion of the epoxy resin is 22.2%; the mass proportion of the curing agent is 1.3%; the mass proportion of the absorbent material is 2.1%; the mass proportion of the antioxidant is 0.06%; the mass proportion of the curing accelerator is 0.64%. Alternatively, the mass proportion of the carbon filament in the support plate is 70%; the mass proportion of the epoxy resin is 25%; the mass proportion of the curing agent is 1.5%; the mass proportion of the absorbent material is 2.4%; the mass proportion of the antioxidant is 0.1%; the mass proportion of the curing accelerator is 1%.

In a feasible embodiment, the tensile strength of the support plate 12 is larger than or equal to 700 Mpa, and the elastic modulus of the support plate is larger than or equal to 70 Gpa. In this case, the support plate 12 can be applied to the flexible support unit 10 to meet the bending-and-folding requirement. For example, the tensile strength of the support plate may be 700 Mpa, 800 Mpa, 850 Mpa, 1 Gpa, 10 Gpa, 30 Gpa, 55.5 Gpa, 70 Gpa or the like.

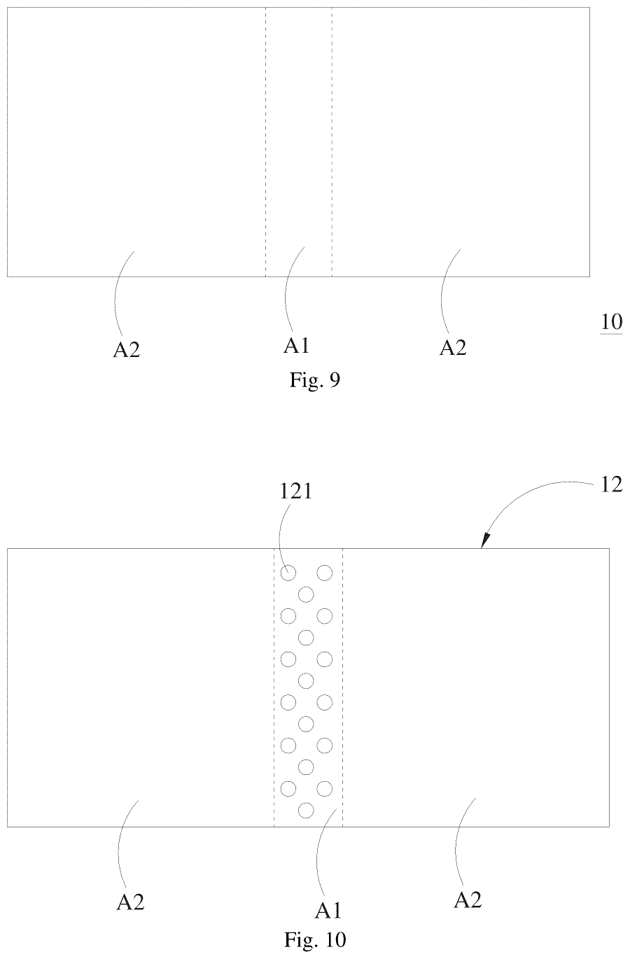

In a feasible embodiment, as shown in FIG. 9, the support unit 10 includes a bending region A1 and a non-bending region A2, and the non-bending region A2 is adjacent to the bending region A1. As shown in FIG. 10, the support plate 12 includes a plurality of first stress-releasing holes 121 located within the bending region A1.

In the above embodiment, the support unit 10 is a flexible support unit 10, which can be applied to a folding display device. Specifically, the support unit 10 may include one bending region A1 and two non-bending regions A2, and the two non-bending regions A2 located on two sides of the bending region A1. The bending region A1 can be folded and unfolded to allow an angle between the two non-bending regions A2 to decrease and increase. The plurality of first stress-releasing holes 121 are formed in a portion of the support plate 12 located within the bending region A1, so as to improve the bending performance of the bending region A1.

In a feasible embodiment, the isolation layer 13 is located at least within the non-bending regions A2. The isolation layer 13 may be merely located within the non-bending regions A2 to avoid the bending region A1, thereby improving the bending performance of the bending region A1, which is not shown in the Figures.

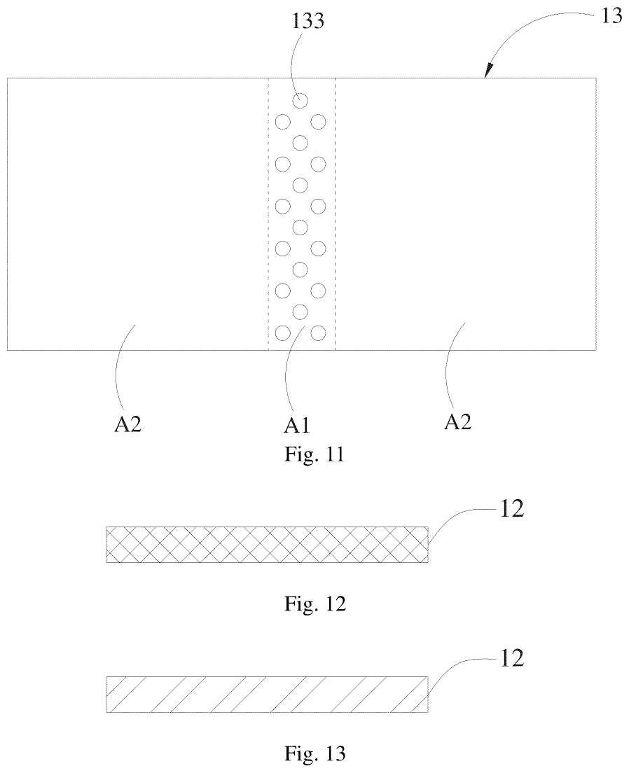

In a feasible embodiment, as shown in FIG. 11, the isolation layer 13 is located in the non-bending regions A2 and the bending region A1, and the isolation layer 13 includes a plurality of second stress-releasing holes 133 located within the bending region A1, so that the bending performance of the bending region A1 can be further improved.

Specifically, the plurality of second stress-releasing holes 133 can be uniformly arranged within the bending region A1, so as to achieve the uniform stress-releasing effect, prevent the isolation layer from being subjected the excessive local stress, and improve the service life of the support plate 12.

Specifically, the first stress-releasing holes 121 correspond to the second stress-releasing holes 133, respectively; that is, an axis of each of the first stress-releasing holes 12 coincides with an axis of each of the second stress-releasing holes 133, so as to reduce an area of a surface of the support plate 12 exposed through the second stress-releasing holes 133, reduce a contact area between the moisture passing through the second stress-releasing holes 133 and the support plate 12, or reduce the impact of the high temperature passing through the second stress-releasing holes 133 on the support plate 12, and further reduce the probability of generating the gas in the support plate 12.

Specifically, the first stress-releasing holes may be through holes or blind holes; the second stress-releasing holes may be through holes or blind holes. The through holes can further improve the bending performance, and the blind holes can reduce the probability of moisture intrusion and improve the support performance. It should be noted that a groove is also a type of hole.

In another feasible embodiment, a portion of the isolation layer 13 located within the bending region A1 may be a complete flat surface without the holes, thereby further improving the moisture-isolating effect and the heat-isolating effect and reducing the probability of generating the gas in the support plate 12.

As shown in FIG. 12, the present application provides another support unit 10, which is arranged on a non-light-emitting surface 111 of a display panel 11. The support unit 10 includes a support plate 12, and components of the support plate 12 include a moisture-absorbing material.

By doping the moisture-absorbing material into the support plate 12, the moisture can be absorbed by the moisture-absorbing material firstly after entering into the support plate 12, so as to preventing the moisture from reacting with the curing agent including the dicyandiamide material, reduce the probability of generating the gas by the reaction between the dicyandiamide in the curing agent and the moisture, and improve the yield of the support unit 10.

In the above embodiment, the moisture-absorbing material includes at least one of acrylic ester, polyvinyl alcohol, vinyl acetate copolymer, polyurethane, polyethylene oxide or starch graft copolymer. The present application does not particularly limit this and the components can be selected according to the actual needs.

In the above embodiment, the components of the support plate 12 include epoxy resin, carbon filament, curing agent, antioxidant, and curing accelerator. Curing agents include dicyandiamide.

In the above embodiment, the antioxidant includes at least one of diaryl secondary amine or p-phenylenediamine derivative.

In the above embodiment, the curing accelerator includes at least one of dimethylaminomethylphenol or benzyl dimethylamine.

In the above embodiment, in the support plate, a mass proportion of the carbon filament is from 70% to 75%; a mass proportion of the epoxy resin is from 20% to 25%; a mass proportion of the curing agent is from 1% to 1.5%; a mass proportion of the moisture-absorbing material is from 2% to 2.5%; a mass proportion of the antioxidant is from 0.05% to 0.1%; a mass proportion of the curing accelerator is from 0.5% to 1%.

Specifically, in the support plate, the mass proportion of the carbon filament is 75%; the mass proportion of the epoxy resin is 21%; the mass proportion of the curing agent is 1%; the mass proportion of the absorbent material is 2%; the mass proportion of the antioxidant is 0.1%; the mass proportion of the curing accelerator is 0.9%. Alternatively, in the support plate, the mass proportion of the carbon filament is 71.25%; the mass proportion of the epoxy resin is 24.3%; the mass proportion of the curing agent is 1.4%; the mass proportion of the moisture-absorbing material is 2.23%; the mass proportion of the antioxidant is 0.07%; the mass proportion of the curing accelerator is 0.75%. Alternatively, in the support plate, the mass proportion of the carbon filament is 73.7%; the mass proportion of the epoxy resin is 22.2%; the mass proportion of the curing agent is 1.3%; the mass proportion of the absorbent material is 2.1%; the mass proportion of the antioxidant is 0.06%; the mass proportion of the curing accelerator is 0.64%. Alternatively, the mass proportion of the carbon filament in the support plate is 70%; the mass proportion of the epoxy resin is 25%; the mass proportion of the curing agent is 1.5%; the mass proportion of the absorbent material is 2.4%; the mass proportion of the antioxidant is 0.1%; the mass proportion of the curing accelerator is 1%.

In a feasible embodiment, the tensile strength of the support plate 12 is larger than or equal to 700 Mpa, and the elastic modulus of the support plate is larger than or equal to 70 Gpa. In this case, the support plate 12 can be applied to the flexible support unit 10 to meet the bending-and-folding requirement. For example, the tensile strength of the support plate may be 700 Mpa, 800 Mpa, 850 Mpa, 1 Gpa, 10 Gpa, 30 Gpa, 55.5 Gpa, 70 Gpa or the like.

In a feasible embodiment, as shown in FIG. 9, the support unit 10 includes a bending region A1 and a non-bending region A2. The non-bending region A2 is adjacent to the bending region A1. Referring to FIG. 10, the support plate 12 includes a plurality of first stress-releasing holes 121 located within the bending region A1.

In the above embodiment, the support unit 10 is a flexible support unit 10, which can be applied to a folding display device. Specifically, the support unit 10 may include one bending region A1 and two non-bending regions A2, and the two non-bending regions A2 located on two sides of the bending region A1. The bending region A1 can be folded and unfolded to allow an angle between the two non-bending regions A2 to decrease and increase. The plurality of first stress-releasing holes 121 are formed in a portion of the support plate 12 located within the bending region A1, so as to improve the bending performance of the bending region A1.

Specifically, the plurality of first stress-releasing holes 121 can be uniformly arranged within the bending region A1, so as to achieve the uniform stress-releasing effect, prevent the isolation layer from being subjected the excessive local stress, and improve the service life of the support plate 12.

Further, the first stress-releasing holes may be through holes or blind holes. The through holes can further improve the bending performance, and the blind holes can reduce the probability of moisture intrusion and improve the support performance. It should be noted that a groove is also a type of hole.

As shown in FIG. 13, the present application provides another support unit 10, which is arranged on a non-light-emitting surface 111 of a display panel 11. The support unit includes a support plate 12. Components of the support plate include epoxy resin, carbon filament, curing agent, antioxidant and curing accelerator. Among them, the curing agent includes aliphatic amine curing agent or aromatic diamine curing agent.

In this case, the curing agent may not include dicyandiamide, so as to eliminating the gas generated by the reaction between the dicyandiamide and the moisture.

In the above embodiment, the aliphatic amine curing agent includes at least one of ethylenediamine, hexamethylenediamine, diethylenetriamine or triethylenetetramine. Alternatively, the aliphatic amine curing agent may include other specific materials, and the present application does not specifically limit this.

In the above embodiment, the aromatic diamine curing agent includes at least one of dapsone, diaminodiphenylmethane or m-phenylenediamine. Alternatively, the aromatic diamine curing agent may include other specific materials, and the present application does not specifically limit this.

In the above embodiments, the antioxidant includes at least one of diaryl secondary amine or p-phenylenediamine derivative.

In the above embodiments, the curing accelerator includes at least one of dimethylaminomethylphenol or benzyl dimethylamine.

In the above embodiment, in the support plate, a mass proportion of the carbon filament is from 72% to 78%; a mass proportion of the epoxy resin is from 20.5% to 25.5%; a mass proportion of the curing agent is from 1% to 1.4%; a mass proportion of the antioxidant is from 0.05% to 0.1%; a mass proportion of the curing accelerator is from 0.45% to 1%.

Specifically, in the support plate, the mass proportion of the carbon filament is 72%; the mass proportion of the epoxy resin is 25.5%; the mass proportion of the curing agent is 1.4%; the mass proportion of the antioxidant is 0.1%; the mass proportion of the curing accelerator is 1%. Alternatively, in the support plate, the mass proportion of the carbon filament is 73.75%; the mass proportion of the epoxy resin is 24.55%; the mass proportion of the curing agent is 1.13%; the mass proportion of the antioxidant is 0.07%; the mass proportion of the curing accelerator is 0.5%. Alternatively, the mass proportion of the carbon filament in the support plate is 74.39%; the mass proportion of the epoxy resin is 23.36%; the mass proportion of the curing agent is 1.25%; the mass proportion of the antioxidant is 0.09%; the mass proportion of the curing accelerator is 0.91%. Alternatively, the mass proportion of the carbon filament in the support plate is 78%; the mass proportion of the epoxy resin is 20.5%; the mass proportion of the curing agent is 1%; the mass proportion of the antioxidant is 0.05%; the mass proportion of the curing accelerator is 0.45%.

In a feasible embodiment, the tensile strength of the support plate 12 is larger than or equal to 700 Mpa, and the elastic modulus of the support plate is larger than or equal to 70 Gpa. In this case, the support plate 12 can be applied to the flexible support unit 10 to meet the bending-and-folding requirement. For example, the tensile strength of the support plate may be 700 Mpa, 800 Mpa, 850 Mpa, 1 Gpa, 10 Gpa, 30 Gpa, 55.5 Gpa, 70 Gpa or the like.

In a feasible embodiment, referring to FIG. 9, the support unit 10 includes a bending region A1 and a non-bending region A2. The non-bending region A2 is adjacent to the bending region A1. Referring to FIG. 10, the support plate 12 includes a plurality of first stress-releasing holes 121 located within the bending region A1.

In the above embodiment, the support unit 10 is a flexible support unit 10, which can be applied to a folding display device. Specifically, the support unit 10 may include one bending region A1 and two non-bending regions A2, and the two non-bending regions A2 located on two sides of the bending region A1. The bending region A1 can be folded and unfolded to allow an angle between the two non-bending regions A2 to decrease and increase. The plurality of first stress-releasing holes 121 are formed in a portion of the support plate 12 located within the bending region A1, so as to improve the bending performance of the bending region A1.

Specifically, the plurality of first stress-releasing holes 121 can be uniformly arranged within the bending region A1, so as to achieve the uniform stress-releasing effect, prevent the isolation layer from being subjected the excessive local stress, and improve the service life of the support plate 12.

Further, the first stress-releasing holes may be through holes or blind holes. The through holes can further improve the bending performance, and the blind holes can reduce the probability of moisture intrusion and improve the support performance. It should be noted that a groove is also a type of hole.

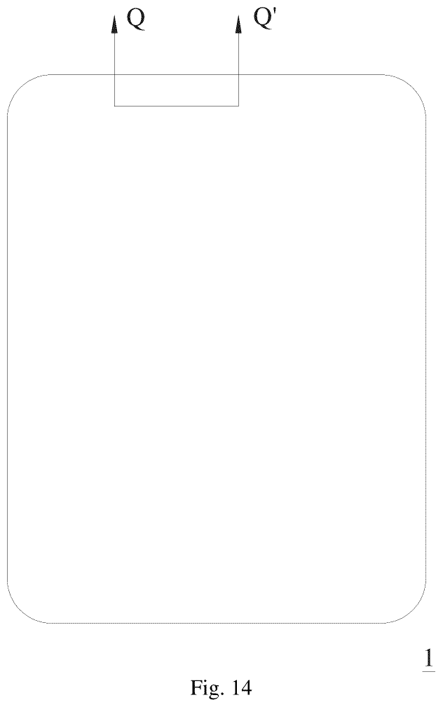

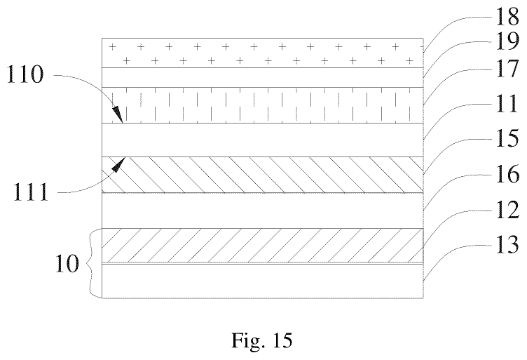

As shown in FIG. 14 and FIG. 15, in a feasible embodiment, the present application further provides a display module 1, including the support unit 10 according to any one of the embodiments of the present application as described above.

Since the display module 1 provided by the present application includes the support unit 10 according to any one of the embodiments of the present application as described above, the display module 1 provided by the present application has the beneficial effects of the support unit 10 according to any one of the embodiments of the present application as described above, which will not be repeated here.

The display module 1 further includes a display panel 11 and a support film 15. The support film 15 is arranged between the support plate 12 and the display panel 11, and is bonded and fixed to the support plate 12. The support film 15 can be used to support and buffer, which can support the display panel 11, protect the display panel 11, and reduce the probability of damage caused by the stress on a side of the display panel 11 away from the light-emitting side 110.

In the above embodiment, as shown in FIG. 15, the support film 15 and the support plate 12 are bonded and fixed by a double-face adhesive tape 16, which may include polyimide. The double-face adhesive tape 16 is in direct contact with a side of the support plate 12 facing the display panel 11. In the related art, the gas generated in the support plate 12 may generate bubbles on a surface of the double-face adhesive tape 16 in contact with the support plate 12, thereby occurring the bulging phenomenon at the appearance. The support unit 10 provided by the present application can solve the bulging phenomenon by reducing the probability of generating the gas in the support plate 12, so as to improve the yield of the display module.

In a feasible embodiment, as shown in FIG. 15, the display module further includes a polarizer 17, which is arranged on the light-emitting side 110 of the display panel 11, so as to reduce the reflection and improve the display contrast. Of course, in another embodiment, a COE film layer can be used instead of the polarizer 17.

In a feasible embodiment, as shown in FIG. 15, the display module further includes a cover plate 18, which is arranged on a side of the polarizer 17 away from the display panel 11, and is bonded and fixed to the display panel 11.

In the above embodiments, the display module may be a flexible display module, and the cover plate 18 may be a flexible cover plate, so as to achieve bending and winding the flexible module. Specifically, the cover plate 18 is bonded and fixed to the display panel 11 by a transparent optical adhesive 19, which can reduce the impact on the light-emitting effect.

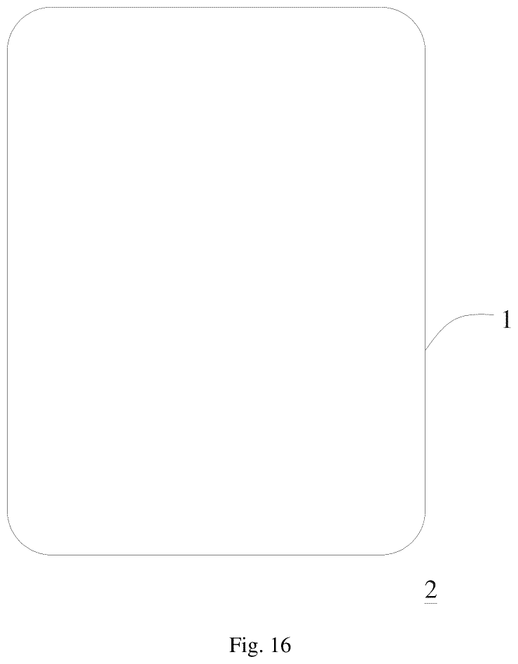

As shown in FIG. 16, the present application further provides a display device 2, including the display module 1 according to any one of the embodiments as described above.

Since the display device 2 provided by the present application includes the display module 1 according to any one of the embodiments as described above, the display device 2 provided by the present application has the beneficial effects of the display module 1 according to any one of the embodiments as described above, which will not be repeated here.

The display device 2 in the embodiments of the present application may be, but not limited to, a devices with the display function, such as a mobile phone, a personal digital assistant (PDA), a tablet, an e-book, a television, an access control, a smart landline phone, a console.

According to the embodiments described above in the present application, these embodiments do not elaborate on all details and do not limit the application to the specific embodiments. Obviously, based on the above description, various modifications and changes can be made. The present application selects and specifically describes these embodiments in order to better explain the principle and the practical application of the present application, so that those skilled in the art can effectively apply the present application and the modifications based on the present application. The present application is limited only by the claims and their full scope and equivalents.

What is claimed is:

1. A support unit, being arranged on a non-light-emitting surface of a display panel, the support unit comprising:
a support plate, located on a side of the display panel; and
an isolation layer, located on a side of the support plate away from the display panel, and comprising at least one of a moisture-isolating layer or a heat-isolating layer.

2. The support unit according to claim 1, wherein a moisture permeability of the moisture-isolating layer is less than or equal to 10⁻⁴ g/(m²·d); and
an elastic modulus of the moisture-isolating layer is larger than or equal to 3 Gpa and less than or equal to 8 Gpa.

3. The support unit according to claim 1, wherein the moisture-isolating layer comprises a water-oxygen-isolating film, and the water-oxygen-isolating film is bonded and fixed to the support plate through an adhesive layer.

4. The support unit according to claim 3, wherein the water-oxygen-isolating film comprises at least one of an inorganic material film layer or a metal material film layer; or the water-oxygen-isolating film comprises an inorganic material layer, an organic material layer and an inorganic material layer stacked in a direction perpendicular to the support plate;
a thickness of the water-oxygen-isolating film is from 10 μm to 30 μm.

5. The support unit according to claim 1, wherein the moisture-isolating layer comprises an inorganic film-coating layer;
a thickness of the inorganic film-coating layer is from 10 nm to 100 nm.

6. The support unit according to claim 1, wherein the heat-isolating layer comprises a carrier layer and a metal film-coating layer, the carrier layer is fixed to the side of the support plate away from the display panel, and the metal film-coating layer is fixed to a side of the carrier layer away from the support plate;
the carrier layer comprises an organic material;
the organic material comprises polyester or polyimide;
a material of the metal film-coating layer comprises at least one of gold, silver, nickel or aluminum;
a thickness of the carrier layer is from 5 μm to 15 μm;
a thickness of the metal film-coating layer is from 100 nm to 500 nm.

7. The support unit according to claim 1, wherein components of the support plate comprise epoxy resin, carbon filament, curing agent, antioxidant and curing accelerator;
the curing agent comprises aliphatic amine curing agent, aromatic diamine curing agent or dicyandiamide;
the aliphatic amine curing agent comprises at least one of ethylenediamine, hexamethylenediamine, diethylenetriamine or triethylenetetramine;
the aromatic diamine curing agent comprises at least one of dapsone, diaminodiphenylmethane or m-phenylenediamine.

8. The support unit according to claim 7, wherein
a mass proportion of the carbon filament in the support plate is from 72% to 78%;
a mass proportion of the epoxy resin is from 20.5% to 25.5%;
a mass proportion of the curing agent is from 1% to 1.4%;
a mass proportion of the antioxidant is from 0.05% to 0.1%; and
a mass proportion of the curing accelerator is from 0.45% to 1%;
the antioxidant comprises at least one of diaryl secondary amine or P-phenylenediamine derivative; and
the curing accelerator comprises at least one of dimethylaminomethylphenol or benzyl dimethylamine.

9. The support unit according to claim 1, wherein components of the support plate comprise epoxy resin, carbon filament, curing agent, antioxidant, curing accelerator and moisture-absorbing material;
the moisture-absorbing material comprises at least one of acrylic ester, polyvinyl alcohol, vinyl acetate copolymer, polyurethane, polyethylene oxide, or starch graft copolymer.

10. The support unit according to claim 9, wherein
a mass proportion of the carbon filament in the support plate is from 70% to 75%;
a mass proportion of the epoxy resin is from 20% to 25%;
a mass proportion of the curing agent is from 1% to 1.5%;
a mass proportion of the moisture-absorbing material is from 2% to 2.5%;
a mass proportion of the antioxidant is from 0.05% to 0.1%; and
a mass proportion of the curing accelerator is from 0.5% to 1%.

11. The support unit according to claim 1, wherein a tensile strength of the support plate is larger than or equal to 700 Mpa, and an elastic modulus of the support plate is larger than or equal to 70 Gpa.

12. The support unit according to claim 11, wherein the support unit comprises a bending region and a non-bending region, the bending region is adjacent to the non-bending region, and the support plate comprises a plurality of first stress-releasing holes located within the bending region the isolation layer is located at least in the non-bending region;
the isolation layer comprises a plurality of second stress-releasing holes located within the bending region;
the first stress-releasing holes are through holes or blind holes;
the second stress-releasing holes are through holes or blind holes; and
the first stress-releasing holes correspond to the second stress-releasing holes, respectively.

13. A support unit, wherein the support unit is arranged on a non-light-emitting surface of a display panel, and the support unit comprises:
a support plate, located on a side of the display panel, components of the support plate comprising a moisture-absorbing material.

14. The support unit according to claim 13, wherein
the moisture-absorbing material comprises at least one of acrylic ester, polyvinyl alcohol, vinyl acetate copolymer, polyurethane, polyethylene oxide or starch graft copolymer; the components of the support plate further comprises epoxy resin, carbon filament, curing agent, antioxidant and curing accelerator;
the curing agent comprises dicyandiamide;
the antioxidant comprises at least one of diaryl secondary amine or p-phenylenediamine derivative; and
the curing accelerator comprises at least one of dimethylaminomethylphenol or benzyl dimethylamine.

15. The support unit according to claim 13, wherein
a mass proportion of the carbon filament in the support plate is from 70% to 75%;
a mass proportion of the epoxy resin is from 20% to 25%;
a mass proportion of the curing agent is from 1% to 1.5%;
a mass proportion of the moisture-absorbing material is from 2% to 2.5%;
a mass proportion of the antioxidant is from 0.05% to 0.1%; and
a mass proportion of the curing accelerator is from 0.5% to 1%.

16. The support unit according to claim 13, wherein a tensile strength of the support plate is larger than or equal to 700 Mpa, and an elastic modulus of the support plate is larger than or equal to 70 Gpa.

17. A support unit, wherein the support unit is arranged on a non-light-emitting surface of a display panel, and the support unit comprises:
a support plate, located on a side of the display panel, components of the support plate comprising epoxy resin, carbon filament, curing agent, antioxidant and curing accelerator, and the curing agent comprising aliphatic amine curing agent or aromatic diamine curing agent.

18. The support unit according to claim 17, wherein
the aliphatic amine curing agent comprises at least one of ethylenediamine, hexamethylenediamine, diethylenetriamine and triethylenetetramine;
the aromatic diamine curing agent comprises at least one of dapsone, diaminodiphenylmethane or m-phenylenediamine;
the antioxidant comprises at least one of diaryl secondary amine or p-phenylenediamine derivative; and
the curing accelerator comprises at least one of dimethylaminomethylphenol or benzyl dimethylamine.

19. The support unit according to claim 17, wherein
a mass proportion of the carbon filament in the support plate is from 72% to 78%;
a mass proportion of the epoxy resin is from 20.5% to 25.5%;
a mass proportion of the curing agent is from 1% to 1.4%;
a mass proportion of the antioxidant is from 0.05% to 0.1%; and
a mass proportion of the curing accelerator is from 0.45% to 1%.

20. The support unit according to claim 18, wherein a tensile strength of the support plate is larger than or equal to 700 Mpa, and an elastic modulus of the support plate is larger than or equal to 70 Gpa.
